(19) United States
(12) Patent Application Publication
(10) Pub. No.: US 2025/0238213 A1
(43) Pub. Date: Jul. 24, 2025

(54) PERFORMING CONVERSIONS BETWEEN MULTI-TYPE JAVASCRIPT OBJECT NOTATION PROPERTIES AND STATICALLY TYPED PROGRAMMING LANGUAGES

(71) Applicant: International Business Machines Corporation, Armonk, NY (US)

(72) Inventor: Ian Mark HODGES, Horton Heath (GB)

(21) Appl. No.: 18/418,214

(22) Filed: Jan. 19, 2024

(51) Int. Cl. G06F 8/51

(52) U.S. Cl. CPC G06F 8/51

(57) ABSTRACT

A device may determine different data types of an element identified by a JavaScript Object Notation (JSON) schema and may generate a static programming language data structure, for a statically typed programming language, that includes different fields for the different data types. The device may generate a metadata file for performing conversations between JSON messages and the statically typed programming language. The metadata file may identify the element as a multi-type element and identify different conversion rules for converting the different data types between JSON and the statically typed programming language. The device may determine that a conversion of the element is to be performed between JSON data and data of the statically typed programming language. The device may perform the conversion between the JSON data and the data of the statically typed programming language using, at runtime, the metadata file and the static programming language data structure.

### BACKGROUND

The present invention relates to performing data conversion, and for example, relates to performing data conversions between multi-type JavaScript object notation (JSON) properties and statically typed programming languages. JSON is a standardized format for representing structured data. In some examples, a JSON message may be used to store and transmit data objects. Unlike dynamically typed programming languages, data types (of statically typed programming languages) are defined during compile time and cannot be changed during runtime.

### SUMMARY

A computer-implemented method for conversions between JavaScript Object Notation (JSON) and statically typed programming languages, the computer-implemented method comprising: determining different defined data types of an element property identified by a JSON schema; where a JSON property can be defined as having multiple data types, a multi-type property; generating a static programming language data structure, for a statically typed programming language, that includes different fields identifying the different data types; generating a metadata file for performing conversations between JSON messages and the statically typed programming language, the metadata file identifying the element as a multi-type element and identifying different conversion rules for converting the different data types between the JSON messages and the statically typed programming language; and performing a conversion, of a message that includes the element, between a JSON format and the statically typed programming language, performing the conversion including: using, during runtime, the static programming language data structure and the static programming language data structure to perform the conversion.

A computer program product comprising: one or more computer readable storage media, and program instructions collectively stored on the one or more computer readable storage media, the program instructions may comprise program instructions to program instructions to program instructions to determine different data types of an element identified by a JavaScript Object Notation (JSON) schema; program instructions to generate a static programming language data structure, for a statically typed programming language, that includes different fields for the different data types; program instructions to generate a metadata file for performing conversations between a JSON format and a format the statically typed programming language, the metadata file identifying the element as a multi-type element and identifying different conversion rules for converting the different data types between JSON and the statically typed programming language; program instructions to determine, at runtime, that a conversion of the element is to be performed between JSON code and code of the statically typed programming language; program instructions to determine, using the metadata file and at runtime, that the element is a multi-type element; and program instructions to perform the conversion between the JSON data and the data of the statically typed programming language using the metadata file and the static programming language data structure.

A system comprising: one or more devices configured to: determine different data types of an element identified by a JavaScript Object Notation (JSON) schema; generate a static programming language data structure, for a statically typed programming language, that includes different fields for the different data types; generate a metadata file for performing conversations between JSON messages and the statically typed programming language, the metadata file identifying the element as a multi-type element and identifying different conversion rules for converting the different data types between JSON and the statically typed programming language; determine that a conversion of the element is to be performed between JSON data and data of the statically typed programming language; and provide the metadata file and the static programming language data structure to cause the conversion between the JSON data and the data of the statically typed programming language to be performed using, at runtime, the metadata file and the static programming language data structure.

### BRIEF DESCRIPTION OF THE DRAWINGS

FIGS. 1A-1H are diagrams of an example implementation described herein.

FIG. 2 is a diagram of an example computing environment in which systems and/or methods described herein may be implemented.

FIG. 3 is a diagram of example components of one or more devices of FIG. 1.

FIG. 4 is a flowchart of an example process associated with performing conversions between JSON and statically typed programming languages.

FIG. 5 is a flowchart of an example process associated with performing conversions between JSON and statically typed programming languages.

### DETAILED DESCRIPTION

The following detailed description of example implementations refers to the accompanying drawings. The same reference numbers in different drawings may identify the same or similar elements.

A JSON schema is a standard that defines language for describing a structure of JSON documents. In some examples, a JSON schema may describe JSON messages that may flow between different applications. A JSON schema may identify a data type of an element. As used herein, an “element” may be used to refer to a property of an object defined by a JSON schema. The data type of an element may be a string, a number, an object, an array, and a Boolean.

In some situations, JSON messages may be converted to messages of a statically typed programming language, such as common business-oriented language (COBOL), programming language one (PL/I), C programming language, among other examples. For example, a JSON schema may define an element with a particular data type and a program may be used to perform a conversion between the JSON message and a message of the statically typed message. For instance, the JSON message may include an element that is a string along with a value of the string and the program may convert the JSON message to a corresponding message of the statically type language that identifies the element as a string along with the value of the string.

In some situations, a JSON schema may identify a multi-type element. A “multi-type element” may be used to refer to an element with different data types. For example, the element may be a string, an integer, an array, an object, or a Boolean. Due to the dynamic nature of JSON, the data type of the element (selected out of the different data types) may be unknown until runtime.

In contrast, elements of statically typed programming languages are not multi-type elements. Rather, data types (of statically typed programming languages) are defined during compile time and cannot be changed during runtime. Accordingly, representing multi-type elements in the statically typed programming languages may be a challenging task because the statically typed programming language support elements that are of a single data type.

Additionally, or alternatively, due to the data type of the multi-type element being unknown until runtime, determining a manner for processing the data type for a conversion to the statically typed programming language may be difficult. The conversion may consume numerous computational cycles in attempting to identify the actual data type.

Additionally, if an erroneous data type is selected, an application utilizing code in the statically typed programming language may experience a failure. Such a failure may cause troubleshooting to be performed. Performing troubleshooting to address the failure may consume computational resources, network resources (if the troubleshooting is performed remotely), and storage resources (e.g., for storing data used for troubleshooting). Accordingly, a need exists for converting JSON messages that include multi-type data elements to a statically typed programming language.

Implementations described herein are directed to performing conversions between multi-type elements of JSON schemas and statically typed programming languages. For example, implementations described herein are directed to a conversion component of a device that may perform the conversions and a generation component that may process a JSON schema and convert the JSON schema to static programming language structures and provide a binary format metadata file used at conversion time to drive the conversion of JSON messages conforming to the JSON schema to and from static programming language structure formats. In some examples, the converted JSON messages may be provided to a static programming language application.

The generation component may perform steps at an application creation time, and a conversion component has steps executed at runtime. In some examples, at generation time, the generation component may analyze a JSON schema and determine different data types of an element that is a multi-type element “location” that may be a number or a string. The different data types may include a number and a string.

Additionally, the different data types may include an object, an array, a number, or a Boolean. The generation component may create a static programming language data structure field, named as the JSON element, for each data type, suffixed with the data type. For example, for a JSON element named “location,” the generation component may create two fields (or variables) “location-number” and “location-string” with appropriate data type (e.g., PIC X(20) or COMP-2, if the statically typed programming language is COBOL). Also, the generation component may create an associated existence flag for each field (e.g., location-number-existence and location-string-existence).

In some implementations, the generation component may generate the static programming language data structure such that fields of the same element with different data types share the same memory location. As example, the conversion component may use COBOL REDEFINES clauses.

The generation component may generate a metadata file that includes conversion rules for converting the different data types between JSON and the statically typed programming language. As an example, in the metadata file, the generation component may mark a field “location” to indicate that the element “location” is a multi-type element and may define all the data types that the field (or the element) can be by using the element name and the data type (e.g. location-number and location-string). The generation component may include the appropriate conversion metadata for each data type.

An application programmer may write a static programming language application to process JSON messages, they will use the generated static programming language data structures to reference the converted JSON data returned by the conversion component at runtime.

The application and the generated metadata file are deployed to a runtime server capable of processing JSON messages.

At runtime, a JSON message may be received as part of a transaction involving an application. At runtime, the conversion component may process each field of the JSON message using the metadata file to initiate the conversion. If the metadata file marks the field of the element as a multi type field, the conversion component may perform additional processing. The conversion component may determine the data type of the element from the JSON message based on the JSON format of the JSON message.

Once the data type is determined, the conversion component may obtain a conversion rule for the data type from the metadata file. For example, the conversion component may search the metadata file using search data that is based on the field name of the element and the data type of the element. For example, the search data may be location-number or location-string. The element (or the field) may be converted (using the conversion rule for the data type) into memory layered by the static programming language structure corresponding to the data type.

In the static programming language data structure, the conversion component may set an existence flag (corresponding to the element and the data type) to true and set other existence flags to false. For example, the conversion component may set the location-number-existence to true and may set the location-string-existence flag false. The conversion component may set the location-number-existence to indicate that a number for the location was received via the JSON message.

A static programming language application will receive the converted JSON message and, based on evaluating (or analyzing) the existence flags of the static programming language data structure, may determine the data type that was received. In some examples, the static programming language application may send a message (e.g., a message of a statically typed programming language). The message may include the element. The static programming language application may identify, in the static programming language data structure, the field corresponding to the element and a data type of the element. For example, the field may be location-string.

The static programming language application may set the corresponding existence flag to true (e.g., set the location-string-existence flag) and set other existence flags to false. At runtime, the conversion component may determine the element and the data type of the element using the static programming language data structure. The conversion component may generate the search data using the name of the element and the data type and use the search data to search the metadata file to identify a conversion rule for converting the data type to a JSON element.

An advantage of performing conversions in this manner is to prevent an erroneous data type from being selected and used by an application. By preventing the erroneous data type from being selected and used, implementations described herein may prevent the application from experiencing a failure. An additional advantage of performing conversions in this manner is to conserve computational resources that would have been used to determine the data type of an element.

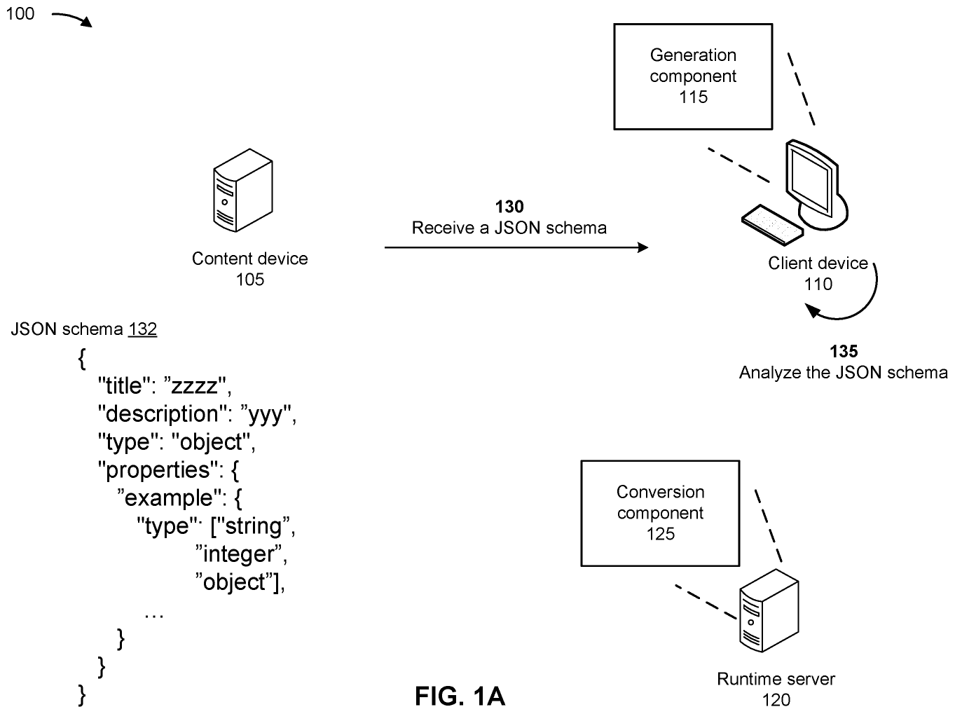

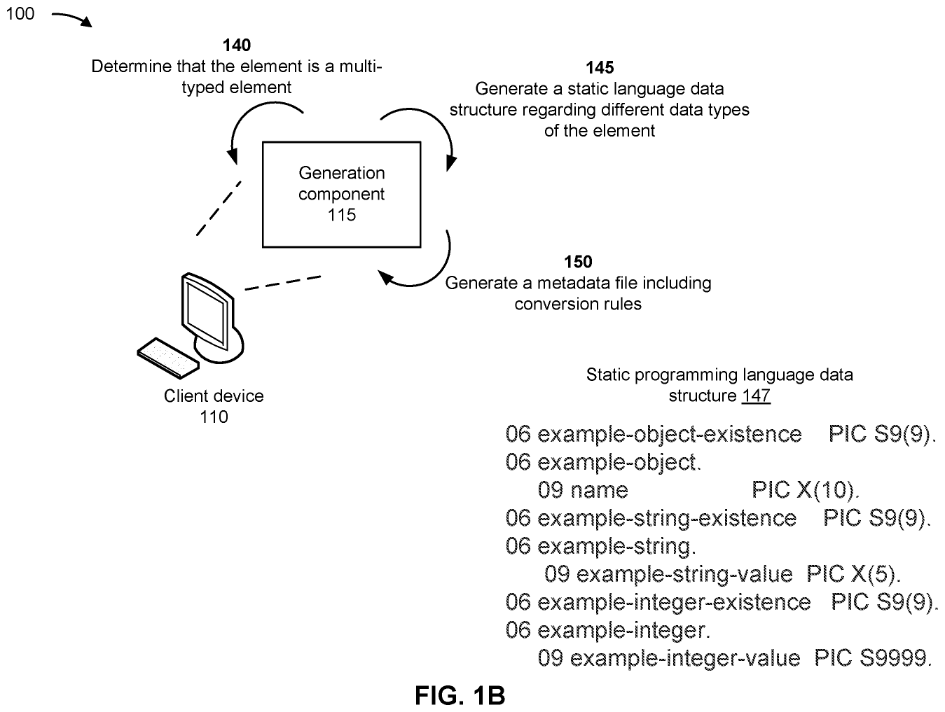

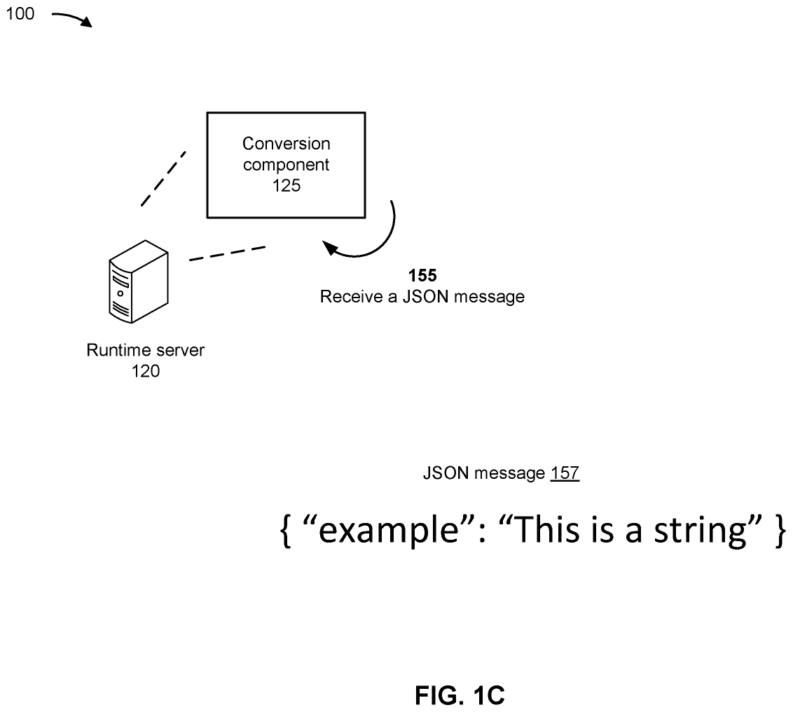

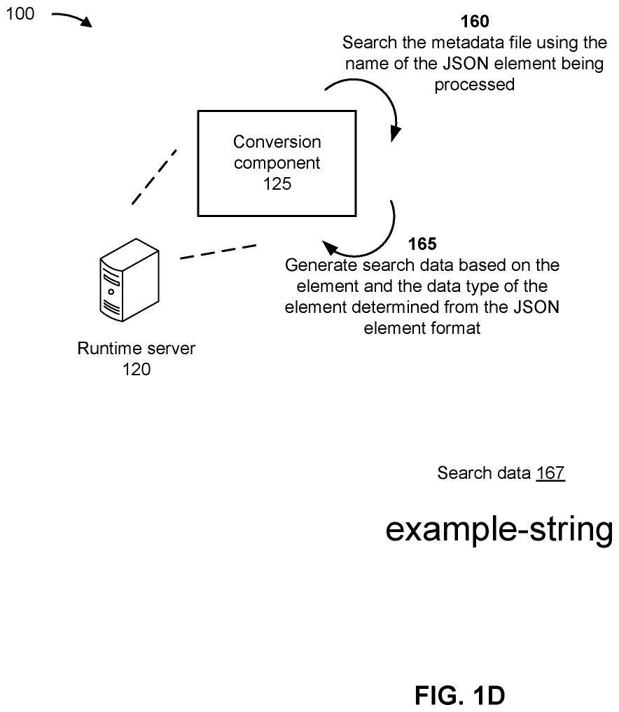

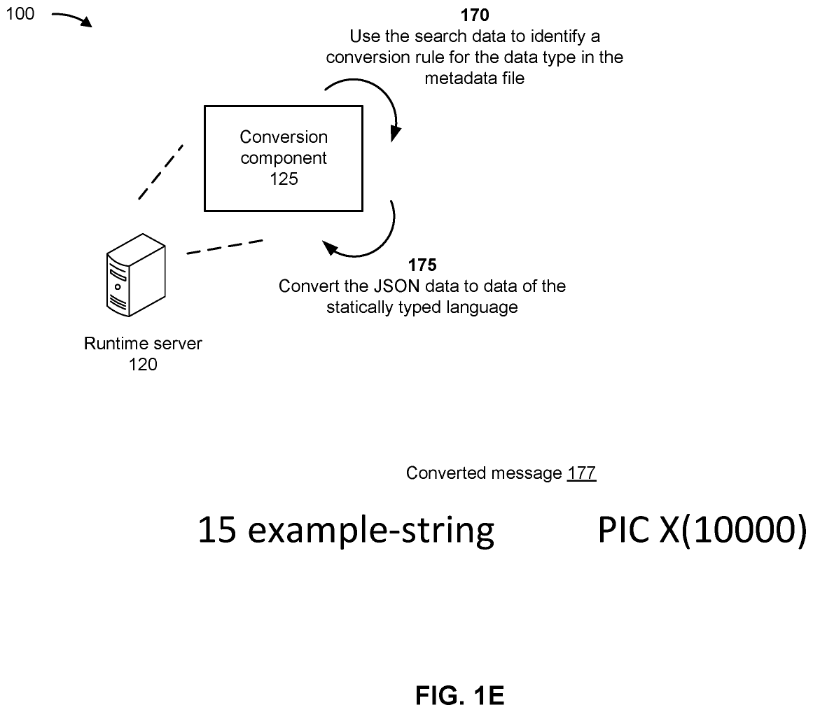

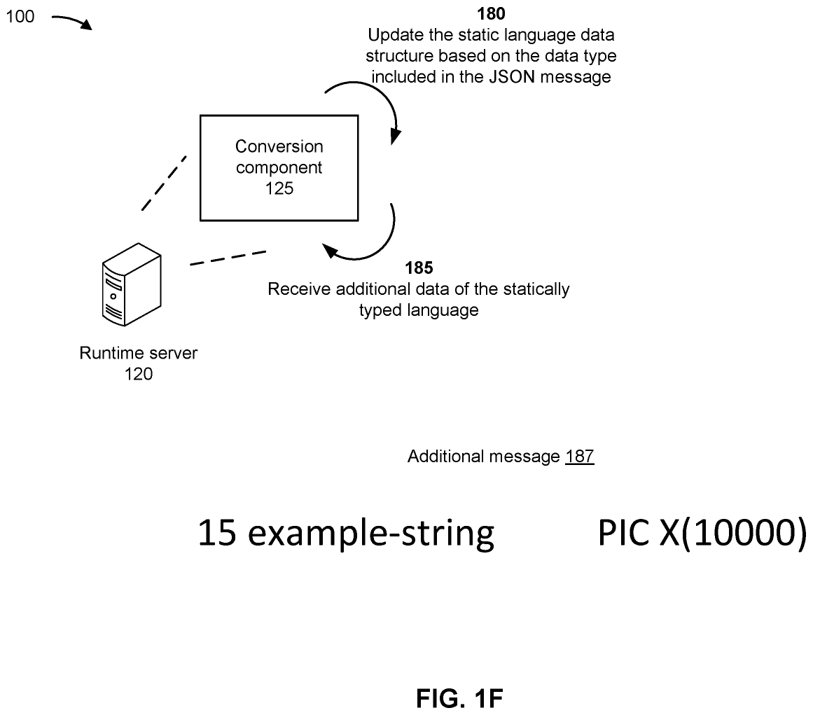

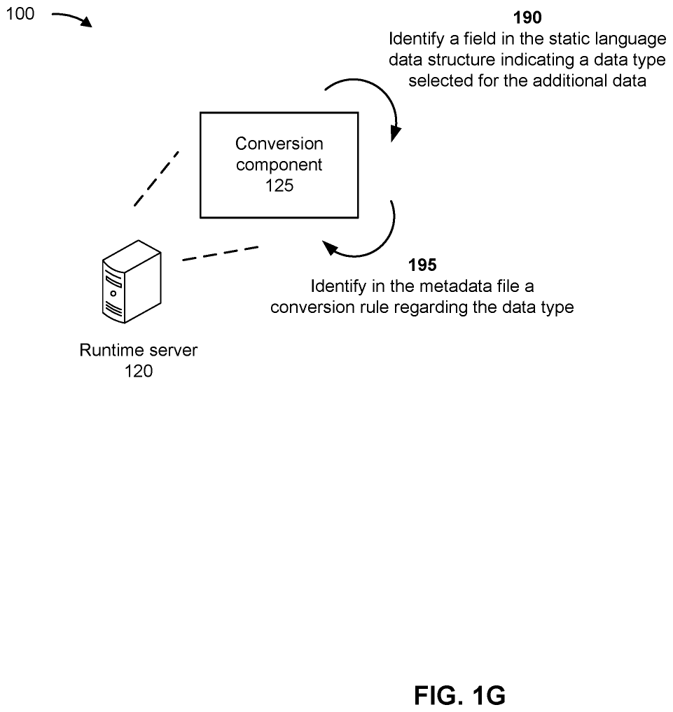

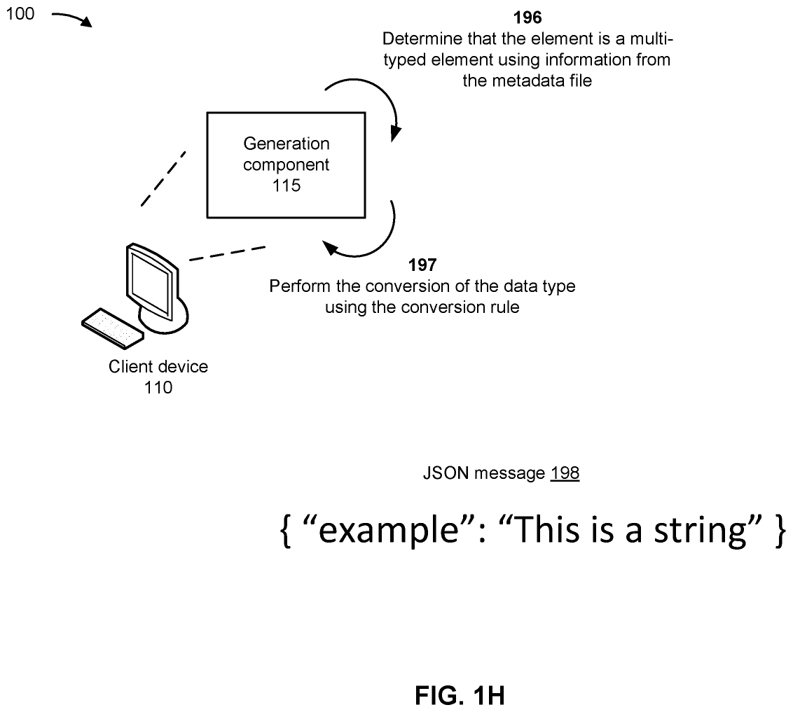

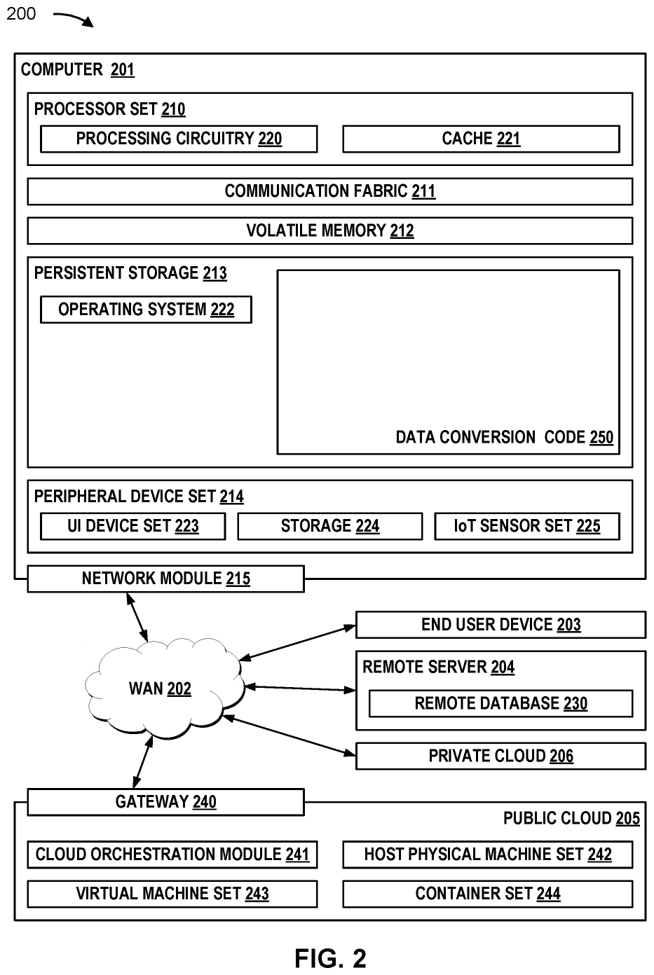

FIGS. 1A-1H are diagrams of an example implementation 100 described herein. As shown in FIGS. 1A-1H, example implementation 100 includes a content device 105, a client device 110, and a runtime server 120. These devices are described in more detail below in connection with FIG. 2.

Content device 105, client device 110, and runtime server 120 may be connected via wired connections, wireless connections, or a combination of wired and wireless connections. The devices may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks. The network enables communication between content device 105, client device 110, and runtime server 120.

Content device 105 may include one or more devices configured to receive, generate, store, process, and/or provide information associated with performing conversions between JSON and statically typed programming languages, as explained herein. For example, content device 105 may provide a JSON schema to client device 110.

Client device 110 may include one or more devices configured to receive, generate, store, process, and/or provide information associated with performing conversions between JSON and statically typed programming languages, as explained herein. Client device 110 may include a communication device and a computing device. For example, client device 110 may include a wireless communication device, a mobile phone, a user equipment, a laptop computer, a tablet computer, a desktop computer, and/or a similar type of device.

As shown in FIG. 1A, client device 110 may include a generation component 115. Generation component 115 may include a tool or a program that generates data used for performing conversions between JSON and statically typed programming languages (e.g., perform conversions between JSON messages and messages of statically typed programming languages). In the example described herein, the statically typed programming language may be COBOL. While the example described herein may refer to COBOL, implementations described herein are applicable to other statically typed programming languages, such as PL/I or the C programming language.

Runtime server 120 may include one or more devices configured to receive, generate, store, process, and/or provide information associated with performing conversions between JSON and statically typed programming languages, as explained herein. Runtime server 120 may include a communication device and a computing device. For example, runtime server 120 may include a wireless communication device, a mobile phone, a user equipment, a laptop computer, a tablet computer, a desktop computer, and/or a similar type of device.

As shown in FIG. 1A, runtime server 120 may include a conversion component 125. Conversion component 125 may include a tool or a program that performs conversions between JSON and statically typed programming languages (e.g., perform conversions between JSON messages and messages of statically typed programming languages). In some implementations, runtime server 120 may include generation component 115 in addition to conversion component 125. Accordingly, runtime server 120 may perform the actions of generation component 115 and conversion component 125, as described herein.

In the example described herein, client device 110 may be used to develop or execute an application that uses a statically type language, such as COBOL. For example, client device 110 may develop or execute the application to exchange data between client device 110 and other devices, such as content device 105.

As shown in FIG. 1A, and by reference number 130, client device 110 may receive a JSON schema 132. In some examples, client device 110 may request the JSON schema for the purpose of facilitating conversions between JSON (e.g., JSON messages) and COBOL language data structures. Client device 110 may receive the JSON schema based on the request. As shown in FIG. 1A, client device 110 may receive the JSON schema. The JSON schema may describe JSON messages that may be received by client device 110 (e.g., received by the application). As shown in FIG. 1A, the JSON schema may identify a property entitled “example” (e.g., an element entitled “example”).

As shown in FIG. 1A, and by reference number 135, client device 110 may analyze the JSON schema. For example, client device 110 (e.g., generation component 115) may analyze the JSON schema to determine attributes of the element “example.” In some situations, based on analyzing the JSON schema, client device 110 may determine that the element “example” is an element with a single data type. Alternatively, based on analyzing the JSON schema, client device 110 may determine that the element “example” is a multi-type element.

As shown in FIG. 1B, and by reference number 140, client device 110 may determine that the element is a multi-type element. For example, based on analyzing the JSON schema, client device 110 (e.g., generation component 115) may determine that the element “example” may have different data types, such as a string, an integer, or an object. In this regard, based on determining that the element is a multi-type element, generation component 115 may determine that the data type of the element may be unknown until runtime. Accordingly, generation component 115 may determine additional processing may occur when performing conversions of the element between JSON code and COBOL code. For example, client device 110 may generate a data structure and a metadata file to facilitate such conversions, as shown in FIG. 1B.

As shown in FIG. 1B, and by reference number 145, client device 110 may generate a static programming language data structure 147 regarding the different data types of the element. For example, based on determining that the element is a multi-type element, client device 110 (e.g., generation component 115) may generate a static programming language data structure for each data type of the element. The static programming language data structure may include different fields representing the different data types. As an example, when the JSON schema is processed, the element “example” may be mapped to a static typed data structure with pair of attributes for each data type that is defined, suffixed with the data type of the element (e.g., object, string, integer, among other examples).

As shown in FIG. 1B, the static programming language data structure may include a field “example-object” for the element being an object, a field “example-string” for the element being a string, and a field “example-integer” for the element being an integer. As shown in FIG. 1B, the static programming language data structure may include a field “example-string-value” to store a value of the element being a string, a field “example-integer-value” to store a value of the element being an integer, and so on.

As shown in FIG. 1B, the static programming language data structure may include a field suffixed with the term “existence.” For example, if set to 1, the field example-string-existence will denote, at runtime, whether the element with the data type string is populated. For example, if a JSON message contained {“example”: “zzzzz”} was received, then “zzzzz” will be converted and stored in field example-string-value and example-string-existence will be set to 1 to indicate that a string data type was received. Similarly, if a JSON message contained {“example”: 1234} was received, then 1234 will be converted and stored in field example-integer-value and example-integer-existence will be set to 1 to indicate that an integer data type was received.

As shown in FIG. 1B, the static programming language data structure illustrates the data type using discrete memory locations. In some situations, generation component 115 may generate the static programming language data structure using the COBOL REDEFINES clause such that each data type shares the same memory location at runtime. For example, two or more fields (identifying two or more data types) may share a same memory location. By causing the two or more fields to share the same memory location, the static programming language data structure may preserve storage resources that would have been used to store the different data types.

In other words, the COBOL REDEFINES clause may save memory. When using the COBOL REDEFINES clause, a data element that specifically stated the type of the data received so the application can use the correct data description variable, and for arrays a variable to contain the number of elements.

As shown in FIG. 1B, and by reference number 150, client device 110 may generate a metadata file including conversion rules. The metadata file may include a field (a primary field) for the property “element” and additional fields (sub fields or secondary fields) for the different data types. The metadata file may identify the primary field as a multi-type field for a multi-type element without a type discriminator (e.g., information identifying a data type). The secondary fields may be provided with type discriminators identifying the different data types.

In some examples, a conversion rule may include a name of the element, a data type of the element, a memory allocation for the element and/or a value of the element, among other examples. The metadata file may include similar information for additional elements identified by the JSON schema.

In some examples, the secondary fields may include conversion metadata for converting the different data types between JSON and COBOL. For example, one secondary field may include information for converting strings, another secondary field may include information for converting integers, and so on. In this regard, the metadata file may be generated alongside the static programming language data structure to manage the conversion of JSON data to a data structure in the correct format and length. This metadata file may contain details of each JSON element to be managed.

An application program written to process JSON messages using the generated language structures and the generated metadata file are deployed to runtime server 120 to process JSON messages. For example, a compiled application program (which uses the generated language structures) and the generated metadata file may be deployed to runtime server 120 that includes conversion component 125. Accordingly, runtime server 120 may be ready to process JSON messages.

As shown in FIG. 1C, and by reference number 155, runtime server 120 may receive a JSON message 157. For example, after generating the static programming language data structure and generating the metadata file, runtime server 120 may receive the JSON message. As shown in FIG. 1C, the JSON message may include a key-value pair. For example, the key-value pair may include the property “element” and a string “This is a string.” At runtime for a JSON to static programming language structure conversion, when the JSON message is being processed, each field conversion information is sought from the generated metadata file.

As shown in FIG. 1D, and by reference number 160, runtime server 120 may search the metadata file using the JSON element being processed. For example, after receiving the JSON message, runtime server 120 (e.g., conversion component 125) may identify a name of the property from the JSON message and search the metadata file using the name “example” to identify a conversion rule for converting the JSON message to COBOL. Runtime server 120 may determine that the JSON element is a multi-type element based on the metadata of the JSON element included in the metadata file.

Based on searching the metadata file, conversion component 125 may identify a field identifying the property. As explained herein, the field (or primary field) for the property “example” may indicate that the property is a multi-type element. Accordingly, conversion component 125 may determine that the property “example” is a multi-type element.

As shown in FIG. 1D, and by reference number 165, runtime server 120 may generate search data 167 based on the element and the data type of the element determined from the format of the JSON element. For example, based on determining that the element is a multi-type element, runtime server 120 (e.g., conversion component 125) may determine that the metadata file multiple conversion rules for the different data types of the property. Accordingly, runtime server 120 may determine that the metadata file is to be searched to identify a conversion rule for the data type of the property included in the JSON message.

In this regard, runtime server 120 (e.g., conversion component 125) may determine the data type of the property. For example, conversion component 125 may identify data that follows the colon in the JSON message and determine the data type based on the data. If the data is a quotation mark, then the data type is a string. If the data is a number, then the data type is a number (e.g., a real number or an integer). If the data is a curly bracket, then the data type is an object. If the data is a square bracket, then the data type is an array. In the present example, conversion component 125 may determine that the data is a quotation mark and, accordingly, may determine that the data type is a string.

Runtime server 120 (e.g., conversion component 125) may generate the search data based on the element and the data type. For example, runtime server 120 may generate the search data by combining the name of the element and the data type. As shown in FIG. 1D, for example, runtime server 120 may generate the search data as “example-string.”

As shown in FIG. 1E, and by reference number 170, runtime server 120 may use the search data to identify a conversion rule for the data type in the metadata file. For example, runtime server 120 may use the search data to identify a secondary field that includes the conversion rule for strings.

As shown in FIG. 1E, and by reference number 175, runtime server 120 may convert the JSON data to data of the statically typed programming language. For example, runtime server 120 may convert the JSON message to a COBOL message (e.g., converted message 177). As an example, runtime server 120 (e.g., conversion component 125) may store the value “This is a string” in the field example-string-value of the static programming language data structure.

As shown in FIG. 1F, and by reference number 180, runtime server 120 may update the static programming language data structure based on the data type included in the JSON message. For example, in the static programming language structure, the flag for the existence field corresponding to the data type, may be set to indicate the data type received. In the present example, because the data type of the element is a string, the flag for example-string-existence may be set to 1. Conversely, the flag for the existence fields of other data types may be set to 0 to indicate that no other data types was received.

As shown in FIG. 1F, and by reference number 185, runtime server 120 may receive additional data of the statistically typed programming language. For example, runtime server 120 may receive another COBOL message (e.g., additional message 187). As an example, the COBOL message may be provided by the application. In some examples, at runtime the application may update the static programming language data structure to indicate that the COBOL message has been sent. In other words, at runtime for a static programming language conversion to JSON, the application may set the flag to state which dynamic JSON type is required and may prime the appropriate field.

For example, the application may update a secondary field to indicate a data type included in the COBOL message. Additionally, the application may update another secondary field to indicate the data type that was included in the COBOL message. As an example, if the COBOL message include a string, the field example-string-value may be updated to include a value of the string and the flag for the field example-string-existence may be set to 1. Conversely, the flag for the existence fields of other data types may be set to 0 to indicate that no other data types was received.

As shown in FIG. 1G, and by reference number 190, runtime server 120 may identify a field in the static programming language data structure indicating a data type selected for the additional data. For example, runtime server 120 may analyze the static programming language data structure to identify the fields updated by the application. As an example, runtime server 120 (e.g., conversion component 125) may determine that the field example-string-value and that the flag for the field example-string-existence has been set to 1. Accordingly, runtime server 120 may determine that the data type is a string.

As shown in FIG. 1G, and by reference number 195, runtime server 120 may identify a field in the metadata file including a conversion rule regarding the data type. For example, runtime server 120 may search the metadata file to identify a conversion rule for strings, in a manner similar to the manner described above.

As shown in FIG. 1H, and by reference number 196, runtime server 120 may determine that the element is a multi-type element using information from the metadata file. For example, the conversion rule (e.g., metadata information) may contain an indication that the field is a dynamic multitype field. Additionally, or alternatively, the field identifying the element may indicate that the element is a multi-type element.

As shown in FIG. 1H, and by reference number 197, runtime server 120 may perform the conversion of the data type using the conversion rule. For example, runtime server 120 may generate a JSON message 198. In some examples, based on determining that the element is a multi-type element, the type information may be removed from the JSON name. For example, runtime server 120 may modify “example-string” to “example.”

According to implementations described herein, a static programming language structure may be produced to represent the JSON message as described by the JSON Schema. A dynamic multitype field, for each defined type a static field may be generated with a type descriptor appended to the field (e.g. -string). A flag may also be created to indicate which type is used at runtime. A metadata file used at runtime to perform the JSON to language format contains conversion information for each type of the multitype field, plus the original field name with an indicator to state that it is a dynamic multi type. By pre-defining all possible types of the data in a static data structure and using the type as key to conversion data held in the metadata file makes, implementations described herein facilitate the support of dynamic typed JSON elements in the world of static computer languages.

As an example, a user (e.g., a computer programmer) may use client device 110 to generate language structures and a metadata file from a JSON schema. The language structures and the metadata file may be generated using generation component 115. With the language structures generated using generation component 115, the user would develop an application program (e.g., using client device 110) in a structured programming language to perform one or more functions. This compiled application program may use the generated language structures as part of the program to access a converted JSON message. The compiled application program (which uses the generated language structures) and the generated metadata file may be deployed to a runtime server that includes conversion component 125. At runtime, the runtime server may receive a JSON message destined for the application program. Conversion component 125 may convert the JSON message to binary data (e.g., data in a binary format) that matches the generated language structures. Conversion component 125 may provide the binary data to the application program. The application program may start executing and may reference the binary data via the generated language structure and perform the one or more functions.

As indicated above, FIGS. 1A-1H are provided as an example. Other examples may differ from what is described with regard to FIGS. 1A-1H. The number and arrangement of devices shown in FIGS. 1A-1H are provided as an example. A network, formed by the devices shown in FIGS. 1A-1H may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as data conversion code 250. In addition to conversion code 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and conversion code 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in conversion code 250 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in conversion code 250 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

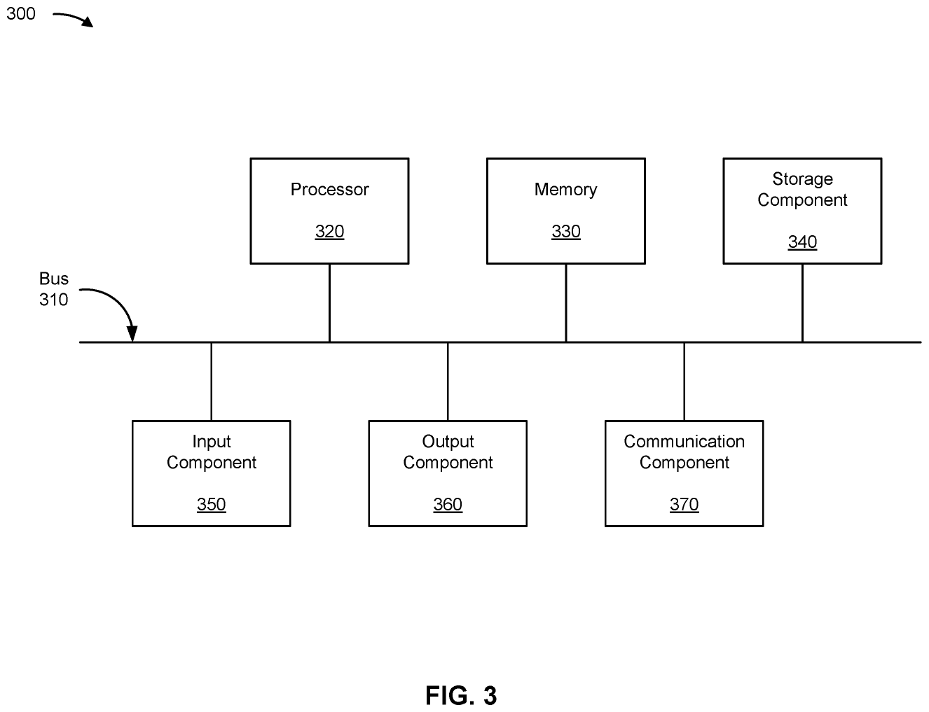

FIG. 3 is a diagram of example components of a device 300, which may correspond to client device 110 and/or runtime server 120. In some implementations, client device 110 and/or runtime server 120 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

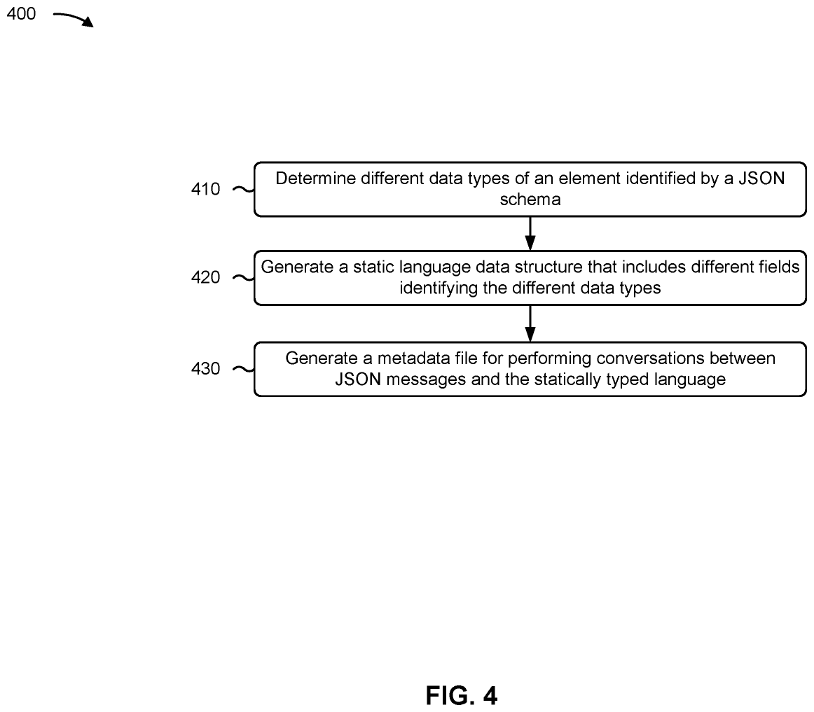

FIG. 4 is a flowchart of an example process 400 associated with performing conversions between JSON and statically typed programming languages. In some implementations, one or more process blocks of FIG. 4 may be performed by a client device (e.g., client device 110). In some implementations, one or more process blocks of FIG. 4 may be performed by another device or a group of devices separate from or including the client device, such as a runtime server (e.g., runtime server 120). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include determining different data types of an element identified by a JSON schema (block 410). For example, the client device may determine different data types of an element identified by a JSON schema, as described above.

As further shown in FIG. 4, process 400 may include generating a static programming language data structure that includes different fields identifying the different data type (block 420). For example, the client device generate a static programming language data structure that includes different fields identifying the different data type, as described above.

As further shown in FIG. 4, process 400 may include generating a metadata file for performing conversations between JSON messages and the statically typed programming language (block 430). For example, the client device may generate a metadata file for performing conversations between JSON messages and the statically typed programming language, as described above. The metadata file may identify the element as a multi-type element and identify different conversion rules for converting the different data types between the JSON messages and the statically typed programming language.

In some examples, a field for the data type, of the different fields of the static programming language data structure, may be updated to indicate that the data type was provided in the JSON data. Other fields, of the different fields of the static programming language data structure, may indicate that other data types, of the different data types, were not provided in the JSON data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

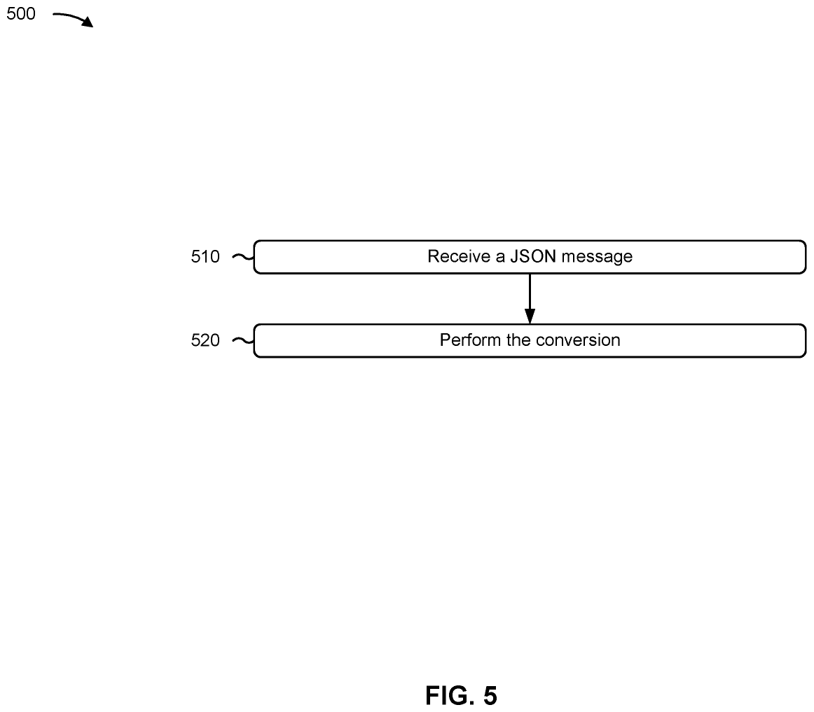

FIG. 5 is a flowchart of an example process 500 associated with performing conversions between JSON and statically typed programming languages. In some implementations, one or more process blocks of FIG. 5 may be performed by a runtime server (e.g., runtime server 120). In some implementations, one or more process blocks of FIG. 5 may be performed by another device or a group of devices separate from or including the runtime server, such as a client device (e.g., client device 110). Additionally, or alternatively, one or more process blocks of FIG. 5 may be performed by one or more components of device 300, such as processor 320, memory 330, storage component 340, input component 350, output component 360, and/or communication component 370.

As shown in FIG. 5, process 500 may include receiving by a JSON schema (block 510). For example, the runtime server may receive by a JSON schema, as described above.

As further shown in FIG. 5, process 500 may include performing the conversion (block 520). For example, the runtime server may perform a conversion, of a message that includes the element, between a JSON format and the statically typed programming language, as described above. Performing the conversion may include using, during runtime, the static programming language data structure and the static programming language data structure to perform the conversion.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
determining different data types of an element identified by a JSON schema;
generating a static programming language data structure, for a statically typed programming language, that includes different fields identifying the different data types;
generating a metadata file for performing conversations between JSON messages and the statically typed programming language,
the metadata file identifying the element as a multi-type element and identifying different conversion rules for converting the different data types between the JSON messages and the statically typed programming language; and
performing a conversion, of a message that includes the element, between a JSON format and the statically typed programming language,
performing the conversion including:
using, during runtime, the static programming language data structure and the static programming language data structure to perform the conversion.

2. The computer-implemented method of claim 1, wherein the message is a JSON message, and
wherein performing the conversion comprises:
determining, using the metadata file, that the element is a multi-type data element;
determining, using the JSON message, a data type of the element;
identifying, in the metadata file, a conversion rule regarding the data type identified using the JSON message; and
converting the JSON message to a message of the statically typed programming language using the conversion rule.

3. The computer-implemented method of claim 1, wherein the message is a particular message of the statically typed programming language, and
wherein performing the conversion comprises:
identifying a field, of the different fields included in the static programming language data structure, that indicates a data type selected for the element in the message of the statically typed programming language;
identifying, in the metadata file, a conversion rule regarding the data type; and
converting the particular message to a JSON message using the conversion rule.

4. The computer-implemented method of claim 1, wherein determining the different data types comprises:
determining the different data types as including a string, a number, an object, an array, and a Boolean.

5. The computer-implemented method of claim 4, wherein generating the metadata file comprises:
generating the metadata file to include a first conversion rule regarding strings, a second conversion rule regarding numbers, a third conversion rule regarding objects, a fourth conversion rule regarding arrays, and a fifth conversion rule regarding Booleans.

6. The computer-implemented method of claim 4, wherein generating the static programming language data structure comprises:
generating the static programming language data structure to include a first field identifying strings, a second field identifying numbers, a third field identifying objects, a fourth field identifying arrays, and a fifth field identifying Booleans,
wherein the different fields include the first field, the second field, the third field, the fourth field, and the fifth field.

7. The computer-implemented method of claim 6, wherein generating the static programming language data structure comprises:
generating the static programming language data structure to cause two or more fields, of the different fields identifying the different data types, to utilize a same memory location at runtime.

8. A computer program product comprising:
one or more computer readable storage media, and program instructions collectively stored on the one or more computer readable storage media, the program instructions comprising:
program instructions to determine different data types of an element identified by a JavaScript Object Notation (JSON) schema;
program instructions to generate a static programming language data structure, for a statically typed programming language, that includes different fields for the different data types;
program instructions to generate a metadata file for performing conversations between a JSON format and a format the statically typed programming language,
the metadata file identifying the element as a multi-type element and identifying different conversion rules for converting the different data types between JSON and the statically typed programming language;
program instructions to determine, at runtime, that a conversion of the element is to be performed between JSON data and data of the statically typed programming language;
program instructions to determine, using the metadata file and at the runtime, that the element is the multi-type element; and
program instructions to perform the conversion between the JSON data and the data of the statically typed programming language using the metadata file and the static programming language data structure.

9. The computer program product of claim 8, wherein the program instructions to perform the conversion comprise:
program instructions to receive the JSON data;
program instructions to analyze the JSON data to determine a data type of the element;
program instructions to generate search data based on the element and the data type of the element;
program instructions to search the metadata file, using the search data, to identify a conversion rule regarding the data type; and
program instructions to convert the JSON data to the data of the statically typed programming language using the conversion rule.

10. The computer program product of claim 9, wherein the program instructions further comprise:
program instructions to update a field for the data type, of the different fields of the static programming language data structure, to indicate that the data type was provided in the JSON data,
wherein other fields, of the different fields of the static programming language data structure, indicate that other data types, of the different data types, were not provided in the JSON data.

11. The computer program product of claim 8, wherein the program instructions to determine the different data types comprise:
program instructions to determine the different data types as including a string, a number, an object, an array, and a Boolean.

12. The computer program product of claim 8, wherein the program instructions to generate the metadata file comprise:
program instructions to generate the metadata file to include a first conversion rule regarding strings, a second conversion rule regarding numbers, a third conversion rule regarding objects, a fourth conversion rule regarding arrays, and a fifth conversion rule regarding Booleans.

13. The computer program product of claim 8, wherein the program instructions to generate the static programming language data structure comprise:
program instructions to generate the static programming language data structure to include a first field identifying strings, a second field identifying numbers, a third field identifying objects, a fourth field identifying arrays, and a fifth field identifying Booleans,
wherein the different fields include the first field, the second field, the third field, the fourth field, and the fifth field.

14. The computer program product of claim 8, wherein the program instructions to generate the static programming language data structure comprise:
program instructions to generate the static programming language data structure to cause two fields, of the different fields, to utilize a same memory location.

15. The computer program product of claim 8, wherein the program instructions to perform the conversion comprise:
program instructions to identify a field, of the different fields included in the static programming language data structure, that indicates a data type selected for the element in the data of the statically typed programming language; and
program instructions to identify, in the metadata file, a conversion rule regarding the data type; and
program instructions to convert the data of the statically typed programming language to the JSON data using the conversion rule.

16. A system comprising:
one or more devices configured to:
determine different data types of an element identified by a JavaScript Object Notation (JSON) schema;
generate a static programming language data structure, for a statically typed programming language, that includes different fields for the different data types;
generate a metadata file for performing conversations between JSON messages and the statically typed programming language,
the metadata file identifying the element as a multi-type element and identifying different conversion rules for converting the different data types between JSON and the statically typed programming language;
determine that a conversion of the element is to be performed between JSON data and data of the statically typed programming language; and
provide the metadata file and the static programming language data structure to cause the conversion between the JSON data and the data of the statically typed programming language to performed using, at runtime, the metadata file and the static programming language data structure.

17. The system of claim 16, wherein, to generate the static programming language data structure, the one or more devices are configured to:
program instructions to generate the static programming language data structure to cause two fields, of the different fields, to utilize a same memory location.

18. The system of claim 16, wherein, to perform the conversion, the one or more devices are configured to:
program instructions to receive the JSON data;
program instructions to analyze the JSON data to determine a data type of the element;
program instructions to identify, in the metadata file, a conversion rule regarding the data type identified using the JSON message; and
program instructions to convert the JSON data to the data of the statically typed programming language using the conversion rule.

19. The system of claim 18, wherein the one or more devices are further configured to:
program instructions to update a field for the data type, of the different fields of the static programming language data structure, to indicate that the data type was provided in the JSON data,
wherein other fields, of the different fields of the static programming language data structure, indicate that other data types, of the different data types, were not provided in the JSON data.

20. The system of claim 16, wherein the one or more devices are further configured to:
program instructions to identify a field, of the different fields included in the static programming language data structure, that indicates a data type selected for the element in the data of the statically typed programming language; and
program instructions to identify, in the metadata file, a conversion rule regarding the data type; and
program instructions to convert the data of the statically typed programming language to the JSON data using the conversion rule.
